(19) United States
(12) Patent Application Publication
(10) Pub. No.: US 2011/0258534 A1
(43) Pub. Date: Oct. 20, 2011

(54) DECLARATIVE DEFINITION OF COMPLEX USER INTERFACE STATE CHANGES

(75) Inventor: Kenneth L. Young, Sammamish, WA (US)

(73) Assignee: Microsoft Corporation, Redmond, WA (US)

(21) Appl. No.: 12/761,418

(22) Filed: Apr. 16, 2010

(51) Int. Cl. G06F 17/24

(52) U.S. Cl. 715/235; 719/328

(57) ABSTRACT

A visual layout system is described herein that supports complex interface transitions between declaratively defined interface templates and states. The system builds a correspondence between an old template and the new template, preserves visual elements that are present in both templates, and changes the visual elements' properties and position in a rendering tree as needed. The system creates or destroys visuals that are only in one template as needed. Using the visual layout system, a designer can specify states of a user interface within a declarative representation of the template that will produce the specified displays. The system allows sweeping state changes to be specified as templates for the designer. Thus, the visual layout system provides designers with an easy facility for specifying complex user interface transitions and manages the transitions at runtime for acceptable performance.

### BACKGROUND

Modern user interface toolkits use layout managers to create user interfaces that can be dynamically resized. Layout managers are software components that have the ability to lay out components (sometimes called widgets) by their relative positions without using distance units. It is often more natural to define component layouts in this manner than to define component positions in pixels or common distance units, so a number of popular widget toolkits include this ability by default. Widget toolkits often allow designers to place widgets in layout containers that have particular layout characteristics when the container is rendered. Windows Presentation Foundation (WPF) and Microsoft Silverlight are two examples of toolkits that provide layout managers. Designers describe user interface components in Extensible Application Markup Language (XAML) and can define user interface states and transitions using an Application Programming Interface (API) such as Microsoft Visual State Manager.

One reason that layout managers are used is to enable automatic resizing of an application, so that user interfaces can work properly on devices with different display resolutions and with resizable, reconfigurable windows. Layout managers are used to automatically determine the layout of graphical elements and controls on a screen. Layout managers typically operate by forcing their children (graphical elements, user interface elements) to conform to a certain layout rule. A stack panel, for example, may force its children into a horizontal or vertical stack, controlling only relative position of the objects with respect to each other. As another example, a uniform grid might force objects to be arranged in a grid, with a fixed size for each child. A table-style layout might force children to conform to row and column definitions, and to define position margins to control positioning and size.

For dynamic user interfaces, it is often useful to transition between different layouts of user interface components. For example, when a user clicks on a “More” button the designer may want the area of one component to expand and display more user interlace controls. For usability reasons, designers like transitions to be smooth and allow for detailed control. In some scenarios, it is sufficient to simply fade between two entirely different user interface screens, but this technique does not work when a layout of graphical elements or user interface controls is designed to morph smoothly from one layout to another. For example, a designer may want a panel to appear to fly out from the left side after a user logs in to an application. Current animation systems, such as Microsoft Visual State Manager, automatically animate transitions from one state to another. In the previous example, the animation system causes the panel to animate from the left side of the display through several intermediate locations before reaching the final fully displayed location.

Designers often want an interface to change substantially upon a particular user action or to add or remove particular controls for different situations. For example, a designer may want to provide differing levels of detail of an interface based on screen/window size of a client viewing the interface. In terminology used by MICROSOFT™ SILVERLIGHT™ and MICROSOFT™ WINDOWS™ Presentation Framework (WPF), a template includes a grouping of controls and can have one or more defined states (e.g., Normal and MouseOver states). Unfortunately, users often want to perform the equivalent of changing templates entirely, but would like the layout system to be smart enough to recognize similarities between templates to animate the interlace between the two looks. For example, if a first interlace has a set of five controls, and a second interface has the same five controls plus two more, it is desirable for the two additional controls to animate into place without affecting the existing five. Today this is usually performed by toggling the visibility of the two additional controls.

This approach leads to three problems. First, the extra controls that were hidden may be too expensive to maintain even in an invisible state. For performance reasons, it is helpful to avoid creating elements that are not being used. Second, getting one layout manager to serve the needs of multiple layouts may be unwieldy; sometimes it is simpler to change the structure of the element hierarchy, by moving certain elements to different layout containers and so on. This is more involved than a simple property change as supported by existing state-based mechanisms. Third, the designer may have created separate designs of the application or control and may have no interest in optimizing the designs to share a common structure even if it is possible to do so, simply because it is ‘work’ to do so. Designers are typically those that focus on a visual layer of an interface in contrast to programmers that focus on a behavioral level of the interface. Visual layout systems that place more power in the hands of designers and do not involve excessive custom software coding or layout customization satisfy a much wider audience.

### SUMMARY

A visual layout system is described herein that supports complex interface transitions between declaratively defined interface templates and states. The system builds a correspondence between an old template and the new template, preserves visual elements that are present in both templates, and changes the visual elements' properties and position in a rendering tree as needed. The system creates or destroys visuals that are only in one template as needed. Using the visual layout system, a designer can specify states of a user interface within a declarative representation of the template that will produce the specified displays. The system allows sweeping state changes to be specified as templates for the designer. Thus, the visual layout system provides designers with an easy facility for specifying complex user interface transitions and manages the transitions at runtime for acceptable performance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the visual layout system, in one embodiment.

FIG. 2 is a flow diagram that illustrates processing of the visual layout system to determine a delta between two templates, in one embodiment.

FIG. 3 is a flow diagram that illustrates processing of the visual layout system to animate a transition between user interface states, in one embodiment.

### DETAILED DESCRIPTION

A visual layout system is described herein that supports complex interface transitions between declaratively defined interface templates and states. In some embodiments, the system expands the definition of a state so that a state of a control can be a set of property changes to either an existing template or an entirely new template. In the case of a new template, the system builds a correspondence between the old template and the new template. The system preserves visual elements that are present in both templates, and changes the visual elements' properties and position in a rendering tree as needed. The system creates or destroys visuals that are only in one template as needed. For example, a first state may include a common control template that includes five controls for viewing a news article. A second state for editing the article includes an additional control that receives additional actions that an editor can perform. Using the visual layout system, a designer can specify the states within a declarative representation of the template (e.g., an extensible markup language (XML) file) that will produce the specified displays. The system allows sweeping state changes to be specified as templates for the designer (since templates are easy to understand). Because creating and tearing down entire templates and groups of controls can have negative performance impact, in some embodiments, the system internally converts the declarative specification and differences between states and templates into tree deltas that the system can render at runtime with an acceptable level of performance (since tree changes are efficient) and without incurring the cost of instantiating a new template from scratch. Thus, the visual layout system provides designers with an easy facility for specifying complex user interface transitions and manages the transitions at runtime for acceptable performance.

The visual layout system can be implemented in a variety of modern interface toolkits and layout managers. One example is MICROSOFT™ SILVERLIGHT™ and MICROSOFT™ WPF. Existing versions of MICROSOFT™ Visual State Manager take XML state descriptions similar to the following (note that this is not the actual syntax but is functionally equivalent and simplified for a more compact representation):

```
<ControlTemplate>
  <VisualStateManager.VisualStateGroups>
    <VisualStateGroup x:Name=“CommonStates”>
      <VisualState x:Name=“NormalState”/>
      <VisualState x:Name=“HoverState”>
        <Setter TargetName=“Container” TargetProperty=“Background”
          Value=“Gray”/>
      </VisualState>
    </VisualStateGroup>
  </VisualStateGroups>
  <Grid x:NameContainer” Background=“White”>
    <RichTextBox x:Name=“EditableMessage”/>
    <TextBlock x:Name=“Label” Text=“{Binding LabelText}”/>
  </Grid>
</ControlTemplate>
```

In this example, a template “ControlTemplate” is defined with a tree of three objects. In the State named “HoverState,” the Background property of the object named “Container” will be gray. A developer can change states with a software call such as, “VisualStateManager.GoToState(this, “HoverState”, true),” where the Boolean property at the end indicates whether the transition will be animated. If the transition is to be animated, there are further structures that are used to define the nature and duration of the animation that are not covered here.

This is extremely useful, but does not handle all cases that designers want to control. Sometimes, the designer wants to change the visuals between several completely different templates. For example, this could happen because the designer individually exported each template from another design tool, or because the different templates use objects so different in nature that it is more performant to only create the objects in the specific template that is currently being displayed.

The visual layout system described herein allows a designer to declaratively define multiple templates, as follows:

```
<ControlTemplate>
  <VisualStateManager.VisualStateGroups>
    <VisualStateGroup x:Name=“CommonStates”>
      <VisualState x:Name=“NormalState”/>
      <VisualState x:Name=“HoverState”>
        <Setter TargetName=“Container” TargetProperty=“Background”
          Value=“Gray”/>
      </VisualState>
    </VisualStateGroup>
    <VisualStateGroup x:Name=“LevelOfDetailStates”>
      <VisualState x:Name=“LowDetail”/>
      <VisualState x:Name=“HighDetail”>
        <ControlTemplate>
          <StackPanel x:Name=“Container” Background=“White”>
            <TextBlock x:Name=“Label” Text=“{Binding LabelText}”
              FontWeight=“Bold”/>
            <Border>
              <RichTextBox x:Name=“EditableMessage”/>
            </Border>
            <ReallyExpensiveVisualizationControl/ >
          </StackPanel>
        <ControlTemplate>
      </VisualState>
  </VisualStateGroups>
  <Grid x:Name=“Container” Background=“White”>
    <RichTextBox x:Name=“EditableMessage”/>
    <TextBlock x:Name=“Label” Text=“{Binding LabelText}”/>
  </Grid>
</ControlTemplate>
```

In this example, two new states (LowDetail and HighDetail) have been added to the previous example, and one of them has a completely different template. For example, the “HighDetail” state includes an additional StackPanel control that includes multiple child controls. Upon changing the state of an instance of this template to the “HighDetail” state, the visuals will be changed to match the new template. This template has many changes from the original: two new elements have been added (the Border and the ReallyExpensiveVisualizationControl), the element named “Container” has changed type (it was a Grid, now it is a StackPanel), the element named “Label” has changed its order in the tree (it was at the end of the collection, now it is at the beginning), the element named “Label” has one of its properties changed (it is now Bold), and the element named “EditableMessage” has changed its level in the tree (it was a direct child of Container, now there is a Border element in between). One job of the visual layout system is to move the contents to the new template while only disturbing the parts that the author would expect. The author would generally expect that elements that are unchanged in both templates would stay as they are (e.g., text the user had been typing into the “EditableMessage” control will be left unchanged), while elements that changed between the templates would animate smoothly into place.

There are at least two approaches to this problem that can be used by the visual layout system. The first approach uses templates at runtime. When building a new tree of elements from a new template, the system first looks for a correspondence between the old template and the new one. In the example above, the correspondence is based on name, or name plus type, but other variations are possible. When the new template specifies that an item be created that matches an element in the old template, the system uses the already instantiated old item instead—and modifies any properties that are explicitly set differently in the old and new templates. When creating a new item, the system inspects the set of active states from other orthogonal state groups (e.g., HoverState in the example, if it is the active state for that group) and applies any property deltas that are supposed to be in effect. In this way, the system translates the displayed interface smoothly from the first to the second template, without disturbing elements that are in both. In addition, the system simplified the designer's task by allowing a compact declarative representation of what the designer wants to occur during state changes.

The second approach uses templates at design time, and deltas at runtime. In other words, although the system is presented to the designer as a set of multiple templates, internally the system treats the setup as a single template with a set of deltas to transition states. In some embodiments, the system compiles the design time representation with a compiler that produces a runtime version of the interface. The compiler is responsible for determining template correspondence and rewriting each state into a set of editing operations. The editing operations for the previous example would look something like: 1) change “Container” to a StackPanel, 2) set the FontWeight of “Label” to Bold, add a Border as the third child of “Container,” move “EditableMessage” to be inside the Border that is the third child of “Container” (note that the Border is now the second child as far as all subsequent instructions are concerned), and add a ReallyExpensiveVisualizationControl as the third child of “Container.” The second approach generally performs faster because the system does not have to analyze templates at runtime. Moreover, the system can handle multiple orthogonal template-based states, though allowing multiple sets of deltas at once introduces the ability to perform conflict resolution including index-based adds/removes. There are well-established techniques in the art for dealing with conflict resolution that the system can apply.

For either approach, upon a template transition, existing visuals often change position, and if the container of an element changes the entire positioning model may change. In some embodiments, the visual layout system animates changes in positions of elements so that elements move smoothly from one location to another. This can be done, for example, by taking a snapshot of each element's position before the state change, observing each elements position after the state change (and before displaying the ending state), and animating each element from a start position to an end position before displaying the final ending state.

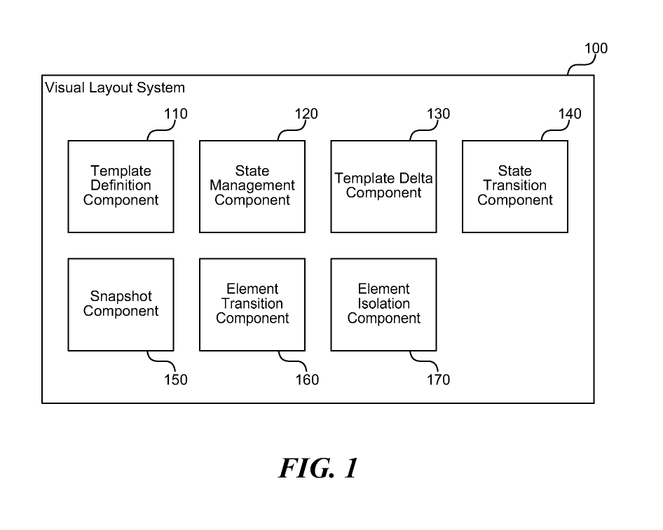

FIG. 1 is a block diagram that illustrates components of the visual layout system, in one embodiment. The system 100 includes a template definition component 110, a state management component 120, a template delta component 130, a state transition component 140, a snapshot component 150, an element transition component 160, and an element isolation component 170. Each of these components is described in further detail herein.

The template definition component 110 receives a declarative definition of templates and states for a user interface from a designer. For example, the designer may use a visual editing tool, such as MICROSOFT™ Blend, that allows the designer to visually create an interface definition that the visual tool exports into a declarative format (e.g., an XML file or other persistent representation). The declarative definition may include base template information, such as controls common to all states or states that use common controls of a template, as well as states that include additional controls added to the common controls. For example, a state for editing an item may include an additional text box that is not present in a state for viewing the item. The template definition component 110 allows the designer to work within a familiar model of placement of controls on a design surface without worrying about behavioral logic used to transfer the interface from one state to another. The system 100 uses the designer's definition to produce an appropriate state transition at runtime.

The state management component 120 stores multiple states in which a user interface can exist and receives an indication to transition from one state to another. The states may be stored in a declarative format, such as a XAML file. Designers may create states by visually laying controls on a canvas in a designer tool or may manually add control definitions to the declarative format file. The declarative format may also contain transition information, such as the conditions that cause a transition (e.g., mouse hover, button click, and so forth) and properties of the transition (e.g., a duration). For example, these may be stored as Triggers and/or VisualStates in a XAML file using Visual State Manager. Transitions may be caused by application logic based on a variety of purposes for different applications.

The template delta component 130 compares templates of incoming and outgoing states to determine a layout of elements and properties that change between the states. The layout properties may include many different property types, such as columns and rows of a grid layout (and column spans and row spans), top and left properties of a canvas, a visibility property, an orientation of a stack, a docking direction in a dock layout, an expanded property of an expander layout, orientation and item width/height of a wrap panel layout, and individual element positional properties (e.g., width, height, minimum width, minimum height, maximum width, maximum height, margins, padding, horizontal alignment, and vertical alignment). In addition, the component 130 may monitor other, non-layout properties when computing the delta because these properties may change between templates as well. The layout may also contain controls or elements that are added to the display and/or taken away by the state change. The system may identify corresponding properties between the templates based on a name or other identifier that is the same for elements in both templates. The system 100 may compare templates at design time, compile time, or runtime. At design time, the system may compile multiple templates into a base template or representation of a template and one or more editing operations that translate the base template into a representation of each state. At runtime, the system invokes the appropriate set of editing operations to perform state transitions. Alternatively, the system can compare the templates at runtime and perform the applicable modifications.

The state transition component 140 generates one or more editing operations to translate from the ingoing state to the outgoing state based on the comparison of templates. The state transition component 140 may include a compiler that acts upon the received declarative definition at design time or a runtime component that dynamically identifies editing operations to transition between templates at runtime. The state transition component 140 performs the steps to take the displayed interface from its initial view in the outgoing state to its new view in the incoming state. In between, the state transition component may invoke the snapshot component 150 and element transition component 160 to produce smooth animated transitions for elements in common between the two state templates.

The snapshot component 150 takes a snapshot that includes a position of each user interface element before a state transition. The position may include a rectangle that is an abstract boundary of the user interface element representing the element's dimensions. Note that the system can also be used to handle three-dimensional animations, so rather than a rectangle the snapshot may include a bounding box and/or a transform. The snapshot component 150 may take two snapshots, one after informing the user interlace element that it is in the outgoing state and another after informing the user interface element that it is in the incoming state. In some embodiments, the visual layout system provides APIs for requesting that a user interface element change states without actually rendering the user interface element. The system can also take a snapshot, perform the state transition (in memory without yet updating the display), and query each element to discover its new position. The system can then animate elements to their new positions before allowing the incoming state to be the active displayed state.

The element transition component 160 transitions an element smoothly between the outgoing state and incoming state. This may include animating visual layout properties as well as changing states of non-layout properties. For example, if an element starts at one position and moves to another, then the element transition component 160 moves the element from the start position to the end position through several intermediate positions in between to provide the appearance of smooth movement to the user. Although rectangles and rectangular coordinates are used as examples herein, those of ordinary skill in the art will recognize that the system can be used with various types of coordinates and transition motion. For example, the system may use a polar coordinate system where elements are animated through a rotation angle. As another example, a particular user interface layout may define a winding path along which elements move to get from the outgoing state to the incoming state. While the set of properties that changes between templates/states will inform which animations to create, the starting value for these animations may be a current value of the property rather than the one that is specified. This makes the process of interrupting a transition with a new transition appear to be smooth.

In some embodiments, the visual layout system 100 includes an element isolation component 170 that isolates the movement of the element from other elements. Because a layout manager dynamically determines element layout and position, changing the size and position of one element may cause the layout of other elements to change. This may be undesirable in the context of transition animation, so the element isolation component 170 may create a temporary container that contains the element that the element transition component 160 is animating. The element isolation component 170 sets the container's size and position based on the incoming state, and then animates the element within the container from its outgoing state position and size to its incoming state position and size. Because the container size and position does not change during the transition, other elements are unaffected by the animation. When the transition is complete, the element isolation component 160 removes the temporary container from the layout. Alternatively or additionally, the layout manager may provide a flag that the layout animation system sets to inform the manager that a particular set of changes to an element do not affect other elements.

The computing device on which the visual layout system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

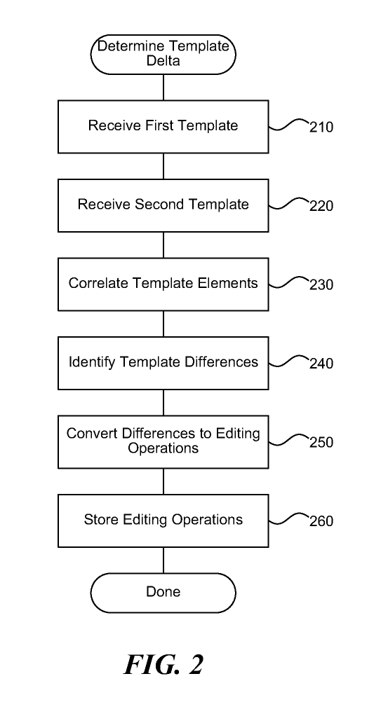

FIG. 2 is a flow diagram that illustrates processing of the visual layout system to determine a delta between two templates, in one embodiment. The following steps may occur at design time, compile time, or run time, depending on how the system is implemented as described further herein. Beginning in block 210, the system receives a first declarative template definition that defines a user interface layout of one or more controls associated with one or more first states. For example, the system may receive an XML or XAML file that includes hierarchical elements that specify controls associated with the first template. The template includes states that a template designer created to represent behavior of the template and ways in which a user's actions or other events can modify the template's layout or properties.

Continuing in block 220, the system receives a second declarative template definition that defines a user interface layout of one or more controls associated with one or more second states, wherein the second template includes at least one control that is related to a control in the first template. For example, the system may identify a second template or set of additions to the first template or a base template that constitute the second template in the same XML or XAML file as the first template. Although it is valid for two templates to be wholly distinct and not share any controls, that case is not illustrated here as it does not result in anything to be transitioned. The second template may represent a user interface state to which the user interface can transition based on user actions. For example, a user may select an item on an e-commerce website and request more detail for the selected item prior to purchasing the item. The user interface may switch from a first template that specifies a list of products to a second template that shows details about a selected product.

Continuing in block 230, the system correlates at least one of the one or more controls in the first template definition with at least one of the one or more controls in the second template definition. For example, the system may identify controls by name and determine that controls are correlated if they have the same name in both templates. Alternatively or additionally, a designer may give controls a numeric or other identifier that the system can match between templates to determine that the controls are related. For items that are correlated between the two templates, the system does not need to instantiate new controls upon transitioning from a user interface based on the first template to one based on the second template (unless the type of the control changes), thus preserving system resources and increasing performance. Examples of items that may be the same in the two templates are a navigational menu that the designer wants to appear the same on every page, a shopping cart icon that appears on every page, an item summary that appears at the top of a summary page and a detail page (where further details are added below the summary), and so forth. The possibilities are limited only by the designer's imagination.

Continuing in block 240, the system identifies one or more differences between the first template definition and second template definition. The differences may include property differences for controls that are correlated in both templates (e.g., a change in background color, change in control type, and so forth), structural changes, or new controls entirely. For example, the second template may include controls that are not present in the first template or exclude controls that are present in the first template. For property changes, the system identifies what changed. For control changes, the system identifies new controls that are to be instantiated and removed controls that are candidates for destruction. Those of ordinary skill in the art will recognize that it may be prudent from a performance perspective to perform lazy destruction, as a quick transition from the second template back to the first template could reuse a previously instantiated version of a control that was not needed during the second template display.

Continuing in block 250, the system creates editing operations based on the identified differences that comprise procedural instructions for transitioning from the user interface layout defined by the first template definition to the user interface layout defined by the second template definition. For example, for changed properties, the system creates editing operations that modify the properties of controls defined in the first and second templates based on the property differences specified in the respective template. For added or removed controls, the system creates editing operations that instantiate or hide controls based on the incoming template definition. For restructuring of controls, the system produces instructions to move the controls to their new location and structure (e.g., if a control has a new type or is now a child of a control of which it was previously a sibling). The procedural instructions may in some cases resemble those that in the past a developer would have added after a designer finished defining user interface states from a layout perspective. However, unlike past systems, the visual layout system produces these transition instructions automatically, avoiding the cost of developer time as well as the potential for mistakes through a manual and error-prone process. Thus, in a very short time span a designer can define user interface layouts and transitions, then view and test his work without waiting for anyone else to add additional software logic.

Continuing in block 260, the system optionally stores the created editing operations in association with one or more states to which the editing operations relate. For example, if the editing operations specify steps for a transition for the first template definition to the second template definition, then the system may store the editing operations in association with the first template so that transition requests from the first template can invoke the editing operations to transition to the user interface layout specified by the second template. The system may store the editing operations in a compiled file representation (e.g., in the case of compiling templates at design time for ease of execution at run time), or may be cached in memory (e.g., in the case of analyzing templates at run time for upcoming transitions). In the runtime case, the system may execute the instructions and discard them without storing them. After block 260, these steps conclude.

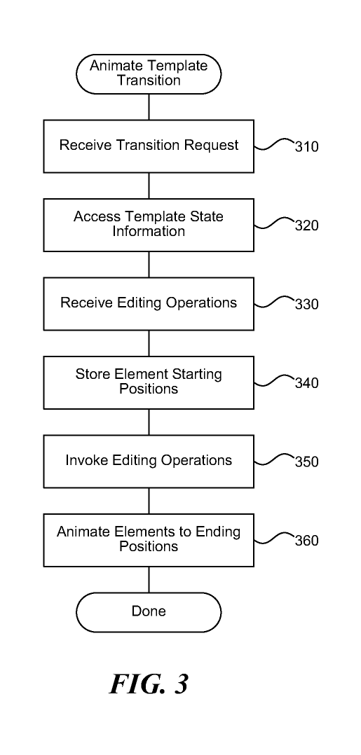

FIG. 3 is a flow diagram that illustrates processing of the visual layout system to animate a transition between user interface states, in one embodiment. Beginning in block 310, the system receives a request to transition from a first state characterized by a first user interface layout to a second state characterized by a second user interface layout. For example, upon receiving an indication that a user clicked a button or activated a link in the first user interface layout, a handler may invoke an API for transitioning to the second state. The user interface layouts can represent a variety of real world desktop application or web application scenarios, and the state transitions represent changes in user interfaces that are typically performed by complex custom designed software code. However, using the visual layout system, a designer can define similar transitions using a declarative representation created through a visual design tool.

Continuing in block 320, the system accesses one or more templates associated with the first and second user interface layouts to identify state information associated with each layout. For example, the state information may identify properties of controls that change between the states, controls that are added to the display in each state, compiled representations of each state, and so forth. Continuing in block 330, the system receives a procedural set of automatically generated editing operations that identify differences between the first user interface layout and the second user interface layout. For example, the editing operations may invoke APIs for setting property values, instantiating controls to be added to the display, hiding or destroying controls to be removed from the display, and so forth. The editing operations may be automatically generated through a design time or runtime compiling process that converts a declarative definition produced by a designer directly or through an editing tool to a compiled representation understood by a user interface runtime platform. If generated at runtime, then the system receives the operations by compiling the declarative definition in place.

Continuing in block 340, the system stores one or more starting positions of elements in the first user interface layout. The starting positions may include a location on a screen or within a window as well as information such as dimensions, color, opacity, and so forth. The system uses the starting position information to produce smooth animations between the first user interface layout and second user interface layout. For example, the system may smoothly animate from one position to another, expand a size from a smaller size to a larger size, transition opacity gradually, and so forth to provide a smooth transition. Continuing in block 350, the system invokes the received editing operations to transition a user interface from the first state to the second state. In some embodiments, the transition initially affects an in-memory representation of the user interface that is not made visible to the user until after the system smoothly animates elements of the first user interface layout to their positions in the second user interface layout. After the animation is complete, the system can display the second user interface layout with the effect seen by the user being a smooth transition between the two layouts.

Continuing in block 360, the system animates the user interface from the stored starting positions of elements in the first user interface layout to one or more ending positions identified by the invoked editing operations. For example, the system may gradually change colors from a color specified in the first user interface layout to a color specified in the second user interface layout. At the end of the animation, the second user interface layout becomes the active layout of the user interface. The system repeats the process for additional state transitions requested by a user's actions or other events defined by the designer that modify the displayed user interface. After block 360, these steps conclude.

In some embodiments, the visual layout system keeps control data for controls that are present in both an outgoing and incoming template in addition to other instance information. For example, a user may have typed text in a text control, selected a particular option in a radio control or combo box control, and so forth. The system can keep these user actions as well as other information held by the control during transitions from one template or state to another. Although this is generally what the user expects, doing so with existing layout managers often incurs the cost of writing custom code to perform this behavior, which may or may not be correctly updated as the user interface changes in version of an application over time. Using the visual layout system, such state preservation can be handled automatically and kept up to date as the user interface changes without explicit focus by the designer or a developer, so that users receive better user interfaces without extra designer effort.

In some embodiments, the visual layout system can produce smooth transitions for controls that change types between two templates. For example, designer may prefer a horizontal list in one user interface layout and a vertical list in another user interface layout. Upon transitioning between the two, the system may move items in the first type of control to the second type of control without extra consideration by the designer. The designer may simply correlate the two controls at design time, such as by giving the two controls the same name or other identifier.

From the foregoing, it will be appreciated that specific embodiments of the visual layout system have been described herein for purposes of illustration, but that various modifications may be made without deviating from the spirit and scope of the invention. Accordingly, the invention is not limited except as by the appended claims.

I/We claim:

1. A computer-implemented method for determining a delta between two user interface templates, the method comprising:
receiving a first declarative template definition that defines a user interface layout of one or more controls associated with one or more first states;
receiving a second declarative template definition that defines a user interface layout of one or more controls associated with one or more second states;
correlating at least one of the one or more controls in the first template definition with at least one of the one or more controls in the second template definition;
identifying one or more differences between the first template definition and second template definition; and
creating editing operations based on the identified differences that comprise procedural instructions for transitioning from the user interface layout defined by the first template definition to the user interface layout defined by the second template definition,
wherein the preceding steps are performed by at least one processor.

2. The method of claim 1 wherein receiving the first declarative template definition comprises receiving an extensible markup language (XML) file that includes hierarchical elements that specify controls associated with the first template.

3. The method of claim 1 wherein receiving the first declarative template definition comprises includes receiving one or more states that a template designer created to represent behavior of the template and ways in which a user's actions or other events can modify the template's layout or properties.

4. The method of claim 1 wherein receiving the second declarative template definition comprises receiving a user interface state to which the user interface can transition based on user actions, wherein the second declarative template definition adds at least one user interface element not present in the first declarative template definition.

5. The method of claim 1 wherein correlating controls comprises identifying controls by identifier and determining that controls are correlated if they have the same identifier in both template definitions.

6. The method of claim 1 wherein correlating controls comprises identifying items that can be displayed upon transition to the second declarative template definition by reusing existing controls and without instantiating new controls.

7. The method of claim 1 wherein identifying differences comprises identifying property value differences for controls that are correlated in both templates.

8. The method of claim 1 wherein identifying differences comprises identifying controls that are present in the second template definition that are not present in the first template definition.

9. The method of claim 1 wherein identifying differences comprises identifying structural changes in controls that are present in the first template definition.

10. The method of claim 1 wherein creating editing operations comprises creating editing operations that modify the properties of controls defined in the first and second templates based on the property differences specified in the respective template.

11. The method of claim 1 wherein creating editing operations comprises creating editing operations that instantiate controls for controls added by the second template definition.

12. The method of claim 1 further comprising storing the created editing operations in association with the first template definition so that transition requests from the first template definition can invoke the editing operations to transition to the user interface layout specified by the second template definition.

13. A computer system for allowing a user interface designer to define complex user interface state changes, the system comprising:
a processor and memory configured to execute software instructions;
a template definition component configured to receive from the user interface designer a declarative definition of one or more templates and states for a user interface;
a state management component configured to store multiple states in which the user interface can exist and receive indications to transition from one state to another;
a template delta component configured to compare templates of one or more incoming and outgoing states to determine a layout of elements and properties that change between the states;
a state transition component configured to generate one or more editing operations to translate from the incoming state to the outgoing state based on the comparison of templates;
a snapshot component configured to take a snapshot that includes a position of each user interface element before a state transition; and
an element transition component configured to transition an element smoothly between the outgoing state and the incoming state.

14. The system of claim 13 wherein the template definition component is further configured to receive user interface definition information from a visual editing tool that allows the designer to visually create an interface definition that the visual tool exports into a declarative format.

15. The system of claim 13 wherein the template definition component is further configured to receive a declarative definition that includes base template information with controls common to all states and additional states that include additional controls added to the common controls for those states.

16. The system of claim 13 wherein the template delta component is further configured to identify corresponding elements between the templates based on an identifier that is the same for elements in both templates.

17. The system of claim 13 wherein the template delta component is further configured to compare templates at design or compile time and compile multiple templates into a base template and one or more editing operations that translate at runtime the base template into a representation of each design time template.

18. The system of claim 13 wherein the state transition component is further configured to invoke a compiler that acts upon the received declarative definition at design time to automatically generate procedural steps to transition the user interface from an initial view in the outgoing state to a new view in the incoming state.

19. A computer-readable storage medium comprising instructions for controlling a computer system to animate a transition between user interface states, wherein the instructions, when executed, cause a processor to perform actions comprising:
receiving a request to transition from a first state characterized by a first user interface layout to a second state characterized by a second user interface layout;
accessing information related to one or more templates associated with the first and second user interface layouts to identify state information associated with each layout;
receiving a procedural set of automatically generated editing operations that identify differences between the first user interface layout and the second user interface layout;
storing one or more starting positions of elements in the first user interface layout;
invoking the received editing operations to transition a user interface from the first state to the second state; and
animating the user interface from the stored starting positions of elements in the first user interlace layout to one or more ending positions identified by the invoked editing operations.

20. The medium of claim 19 wherein receiving editing operations comprise receiving instructions that invoke application programming interfaces (APIs) for setting property values, instantiating controls to be added to the display, and hiding controls to be removed from the user interface.
